(19) United States
(12) Patent Application Publication
(10) Pub. No.: US 2007/0000246 A1
(43) Pub. Date: Jan. 4, 2007

(54) Energy transfer device

(76) Inventor: Nicos Prastitis, London (GB)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/212,168

(22) Filed: Aug. 26, 2005

(30) Foreign Application Priority Data
Jun. 29, 2005 (GB) GB 0513284.0

(51) Int. Cl. F03B 17/02; F03B 13/18

(52) U.S. Cl. 60/504; 60/495

(57) ABSTRACT

An energy transfer device comprises a cylinder connected to a reservoir containing water. First and second pistons are connected to each other by a fixed connecting rod and the pistons are mounted in the cylinder. A pocket is associated with one of the first and second pistons and the first and second pistons are positioned in a first position so that the pocket receives a buoyant object. The pistons are moved to a second position so as to release the buoyant object into the reservoir, the movement of the buoyant object rising to the surface of the water contained in the reservoir providing a driving force.

### FIELD OF THE INVENTION

The present invention relates to an energy transfer device and particularly to an energy transfer device for use with water.

### BACKGROUND OF THE INVENTION

Running water can be harnessed to provide power for machines such as a water mill. A hydroelectric power plant also harnesses the power of running water. The plant typically has a dam on a river to store water in a reservoir. Water released from a reservoir flows through a turbine and the kinetic energy of the flowing water spins the turbine, which in turn activates a generator to produce electricity. The plant thus requires various means to provide and control running water in order to produce electricity.

### SUMMARY OF THE INVENTION

It is an object of the invention to use fluid such as water to transfer energy without the need to harness the kinetic energy of running fluid to transfer energy.

According to one aspect of the present invention there is provided an energy transfer device comprising:

cylinder means connectable to a reservoir containing fluid;

first and second pistons connected to each other by connection means so as to be movable with a constant inter-piston distance, the pistons being mounted in the cylinder means; and

a pocket associated with one of the first and second pistons, wherein the first and second pistons in a first position enable the pocket to receive a buoyant object, and the first and second pistons in a second position enable the pocket to release the buoyant object into the reservoir so that movement of the buoyant object rising to the surface of fluid contained in the reservoir provides a driving force.

The invention makes use of a buoyant force of a fluid in which an object is placed wherein an upward force is exerted by the fluid upon the object being placed in it. The tendency of the object to float or rise when submerged in the fluid is dependent upon the excess of the relative density of the fluid over that of the object. The fluid is preferably water. The energy transfer device may include the reservoir.

The energy transfer device may include first drive means for reciprocating the first and second pistons between the first and second pistons. The pistons are preferably reciprocated in a substantially horizontal direction.

The energy transfer device may include a seal piston movable relative to the connection means between the first and second pistons, and the pocket is formed between one of the first and second pistons and the seal piston. The device may include second drive means for closing up and opening up the pocket.

The device may include first and second seal pistons movable relative to the connection means between the first and second pistons, and a first pocket is formed between the first piston and first seal piston and a second pocket is formed between the second piston and the second seal piston.

The energy transfer device may include driven means which is driven by the driving force provided by the rising buoyant object. The driving force may drive an axle of the driven means.

The energy transfer device may include means for returning a said buoyant object floating at the surface of the reservoir to the pocket when said first and second pistons are in the first position.

At least one of said first and second pistons may contain a said pocket. A pocket may be associated with each of the first and second pistons.

According to another aspect of the present invention there is provided a method of transferring energy comprising the steps of:

providing a reservoir containing fluid, cylinder means connected to the reservoir, first and second pistons connected to each other by connection means so as to be movable with a constant inter-piston distance, the first and second pistons being mounted in the cylinder means, and a pocket associated with one of the first and second pistons;

positioning the first and second pistons in a first position;

receiving a buoyant object in the pocket; and

moving the pistons to a second position so as to release the buoyant object into the reservoir, the movement of the buoyant object rising to the surface of the fluid contained in the reservoir providing a driving force.

The method may include returning the first and second pistons to the first position and may also include returning a said buoyant object floating at the surface of the reservoir to the pocket when the first and second pistons are in the first position.

A said buoyant object or another buoyant object may be received in the pocket.

The pocket formed between one of the first and second pistons and a seal piston movable relative to the connection means between the first and second pistons may be closed up after a said buoyant object contained in the pocket has been released. The pistons may be returned to the first position, and the pocket may be opened up again when the first and second pistons have returned to the first position, or by the time the first and second pistons return to the first position.

First and second seal pistons may be provided which are movable relative to the connection means between the first and second pistons and a first pocket may be formed between the first piston and the first seal piston, and said buoyant object is received in the first pocket. The first pocket may be closed after said buoyant object contained in the first pocket has been released. A second pocket may be formed between the second piston and the second seal piston, and a second buoyant object is received in the second pocket. The second pocket may be closed after said buoyant object contained in the second pocket has been released into the reservoir. The first and second pistons may be returned to the first position, and the first pocket is opened up again when the first and second pistons have returned to the first position or by the time the first and second pistons return to the first position.

According to yet another aspect of the present invention there is provided a method of transferring energy comprising the steps of:

providing a reservoir containing fluid, cylinder means connected to the reservoir, first and second pistons connected to each other by a connection means so as to be movable with a constant inter-piston distance, the pistons being mounted in the cylinder means, and first and second seal pistons movable relative to the connection means;

positioning the first and second pistons in a first position and forming a first pocket between the first piston and the first seal piston;

receiving a first buoyant object in the first pocket;

moving the first and second pistons to a second position so as to release the first buoyant object into the reservoir, the movement of the first buoyant object rising to the surface of the fluid contained in the reservoir providing a driving force;

closing up the first pocket and forming a second pocket between the second piston and the second seal piston;

receiving a second buoyant object in the second pocket;

moving the first and second pistons so as to release the second buoyant object into the reservoir, the movement of the second buoyant object rising to the surface of the fluid contained in the reservoir providing a driving force;

returning the first and second pistons to the first position; and

one of the steps of (i) closing up the second pocket and opening up the first pocket again when the first and second pistons have returned to the first position, and (ii) closing up the second pocket and opening up the first pocket again by the time the first and second pistons return to the first position.

### BRIEF DESCRIPTION OF THE DRAWINGS

Embodiments of the present invention will now be described, by way of example, with reference to the accompanying drawings, in which:

FIG. 1 is a schematic sectional view of an energy transfer device in accordance with a first embodiment of the invention;

FIGS. 2A to 2E are schematic sectional views of the energy transfer device of FIG. 1 in various stages of operation;

FIG. 3 is a modification of FIG. 1;

FIG. 4 is a schematic sectional view of an energy transfer device in accordance with a second embodiment of the invention;

FIGS. 5A to 5E are schematic sectional views of the energy transfer device of FIG. 4 in various stages of operation;

FIG. 6 is a schematic sectional view of an energy transfer device in accordance with a third embodiment of the invention; and

FIGS. 7A to 7E are schematic sectional views of the energy transfer device of FIG. 6 in various stages of operation.

### DESCRIPTION OF THE PREFERRED EMBODIMENTS

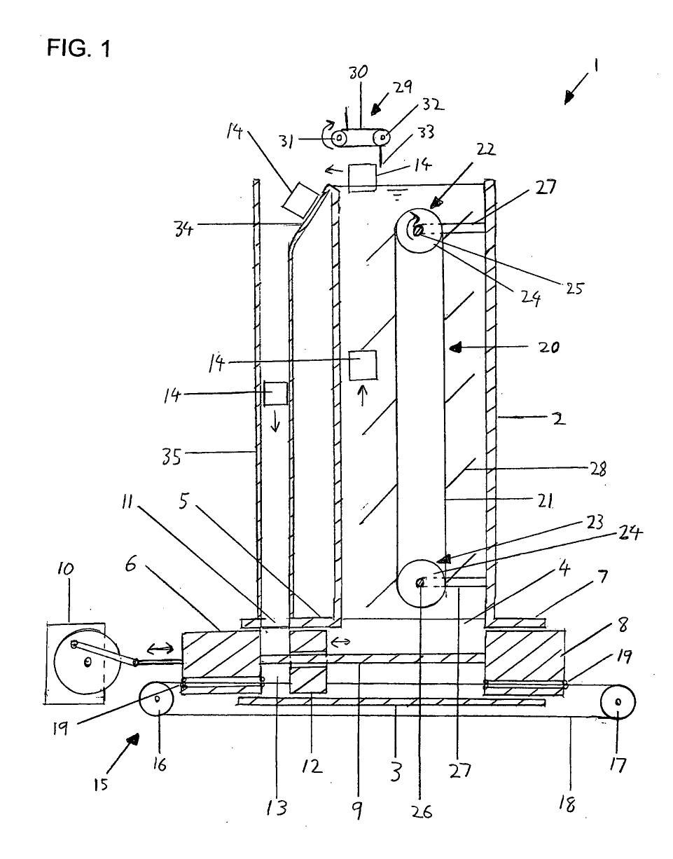

With reference to FIG. 1 of the accompanying drawings, an energy transfer device 1 has a tank or reservoir 2. A cylinder 3 extends horizontally through the tank 2 and beyond opposite sides of the tank and the bottom of the cylinder 3 is level with the bottom of the tank 2. Within the tank 2, the top of the cylinder 3 is open 4. A first portion 5 of the cylinder 3 extends beyond one side of the tank 2 and contains a first piston 6 which protrudes beyond the cylinder 3. A second portion 7 of the cylinder 3 extends beyond the opposite side of the tank 2 and contains a second piston 8 which protrudes beyond the cylinder 3. The first and second pistons 6,8 are connected to each other along their longitudinal axes by a fixed rod 9 and a reciprocating motor 10 is connected to the first piston 6 to drive the pistons 6,8. The pistons 6,8 fit sufficiently tightly within the cylinder 3 so that a water seal is formed between the outer circumferential surface of the pistons 6,8 and the inner circumferential surface of the cylinder 3.

The first portion 5 of the cylinder has an opening 11 in the top of the cylinder 3 parallel to the longitudinal axis of the cylinder 3. The first piston 6 is on one side of the opening 11 and a seal piston 12, movable along the piston connecting rod 9, is between the other side of the opening 11 and the tank 2. The seal piston 12 fits sufficiently tightly around the rod 9 so that a water seal is formed between the seal piston 12 and the rod 9. The gap beneath the opening 11 and between the first piston 6 and the seal piston 12 forms a pocket 13 for receiving a buoyant barrel 14. The seal piston 12 is arranged to be driven along the piston connecting rod 9 by seal piston drive means. The seal piston drive means 15 comprises first and second wheels 16,17 and a wire 18 extending from one side of the seal piston 12, through the first piston 6, around the first wheel 16, underneath the cylinder 3, around the second wheel 17 and through the second piston 8 to the opposite side of the seal piston 12. Seals 19 are formed around the wire 18 passing through the pistons 6,8. When one of the wheels 16,17 is driven the seal piston 12 is moved along the rod 9.

Inside the tank 2 above the cylinder 3 is a mill 20 comprising a belt 21 stretched continuously around a pair of rollers 22,23 arranged one above the other. Each roller 22,23 comprises a plurality of wheels 24 fixed to an axle 25,26 and each axle 25,26 is rotatably supported by supports 27 extending from one side of the tank 2. A plurality of paddles 28 extends at spaced intervals from and around the belt 21. The paddles 28 are all inclined at the same acute angle to the belt 21 and in the same direction relative to the belt 21. The paddles 28 are made of mesh to reduce water resistance.

Above the top of the tank 2 is a barrel removal means 29. This comprises another belt 30 stretched continuously around a pair of rollers 31,32 arranged one beside the other and a plurality of paddles 33 extends at spaced intervals from and around the belt 30. To one side of the belt 30 is a funnel 34 the mouth of which is adjacent the top of one side of the tank 2. The bottom of the funnel 34 is connected to a chute 35, the bottom of which is connected to the opening 11 in the top of the first portion 5 of the cylinder 3.

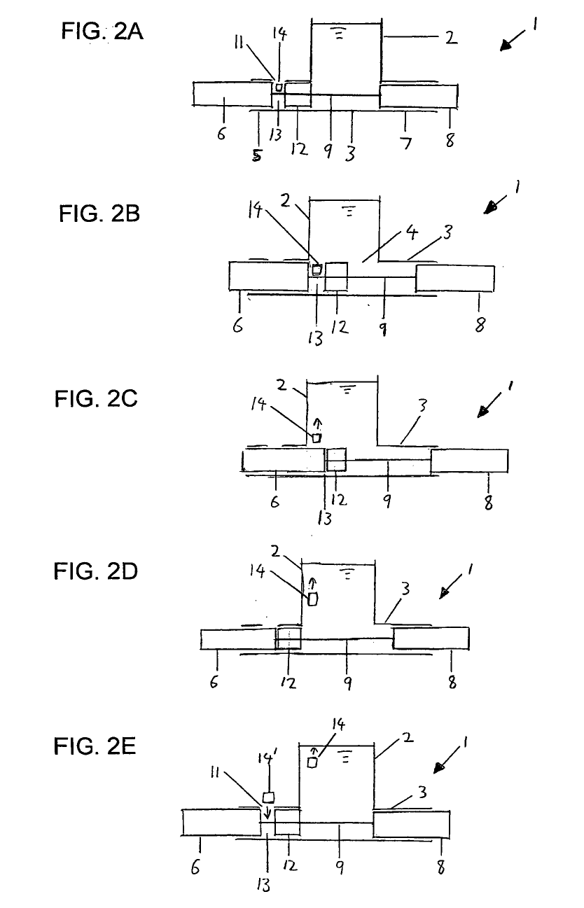

Referring to FIGS. 2A to 2E, the operation of the energy transfer device 1 will now be described. The mill 20, funnel 34, chute 35, barrel removal means 29, reciprocating motor 10 and seal piston drive means 15 have been omitted for clarity.

The tank 2 is filled with water and the seal piston 12 prevents water from the tank 2 leaving via the opening 11 in the top of the first portion 5 of the cylinder 3. A barrel 14 is dropped through the opening 11 into the pocket 1 3 formed between the first piston 6 and the seal piston 12 (FIG. 2A). The motor 10 (see FIG. 1) is started and the pistons 6,8 overcome friction resistance.

The first and second pistons 6,8 are pushed along the cylinder 3 and the fixed connecting rod 9 enables the pistons 6,8 to have a constant inter-piston distance. When the pocket 13 is aligned with the tank 2 the barrel 14 is released through the open part 4 of the cylinder 3 beneath the tank 2 and the buoyancy of the barrel 14 causes it to rise (FIG. 2B).

The rising barrel 14 engages a paddle 28 of the mill belt 21 (see FIG. 1) causing the belt 21 to turn and driving the axles 25,26 of the wheels 24. The upper axle 25 can be connected to, say, a turbine to generate electricity. The mill 20 thus forms driven means.

As the first and second pistons 6,8 reach the maximum extent of their stroke the first piston 6 engages the seal piston 12 causing the pocket 13 to close up (FIG. 2C).

The first piston 6 with the engaged seal piston 12 and the second piston 8 are pulled back along the cylinder 3 (FIG. 2D).

As the first and second pistons 6,8 reach the end of their stroke the first piston 6 disengages from the seal piston 12 causing the pocket 13 to open up. Another barrel 14′ is received in the pocket 13 via the opening 11 and the cycle is repeated.

As more barrels 14 are released into the tank 2 they all engage separate paddles 28 of the mill belt 21. The more barrels 14 that engage the paddles 28 at any one time increase the speed of rotation of the upper axis 25.

When a barrel 14 reaches the surface of the tank 2, it is pushed by a paddle 33 from the belt 30 of the barrel removal means 29 over the edge of the tank 2 and into the funnel 34. From there it falls down the chute 35 and back into the cylinder 3 via the opening 11. The barrel removal means 29, funnel 34 and chute 35 form means for returning a barrel 14 to the cylinder 3.

In a preferred embodiment, the reciprocating motor 10 is a 5 horsepower diesel motor. The pistons 6,8 have a stroke of approximately 1 metre and there is a distance of approximately 1 metre between the barrels 14 rising up to the surface of the tank 2. Each barrel 14 weighs approximately one tonne and there are 95 barrels in circulation in the device 1.

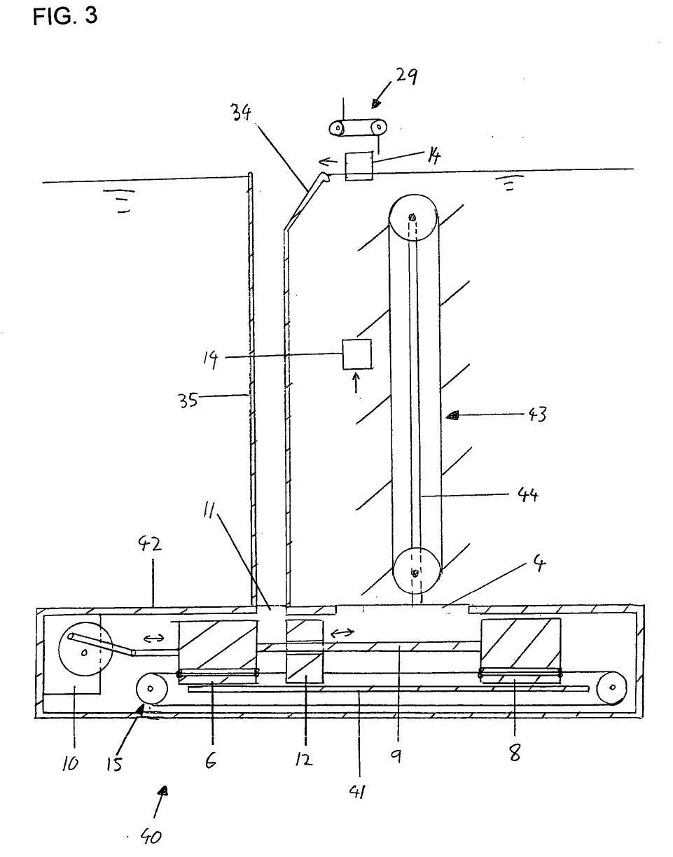

A modified energy transfer device 40 is illustrated in FIG. 3 wherein the device 40 is located underwater and the device 40 consequently no longer requires a tank. The cylinder 41 forms part of a chamber 42 which contains the reciprocating motor 10 and seal piston drive means 15 and seals them from the water in which the device 40 is located. The water in which the device 40 is located may be considered to be a reservoir of water. Also, the mill 43 is supported by supports 44 extending from the chamber 42 beneath.

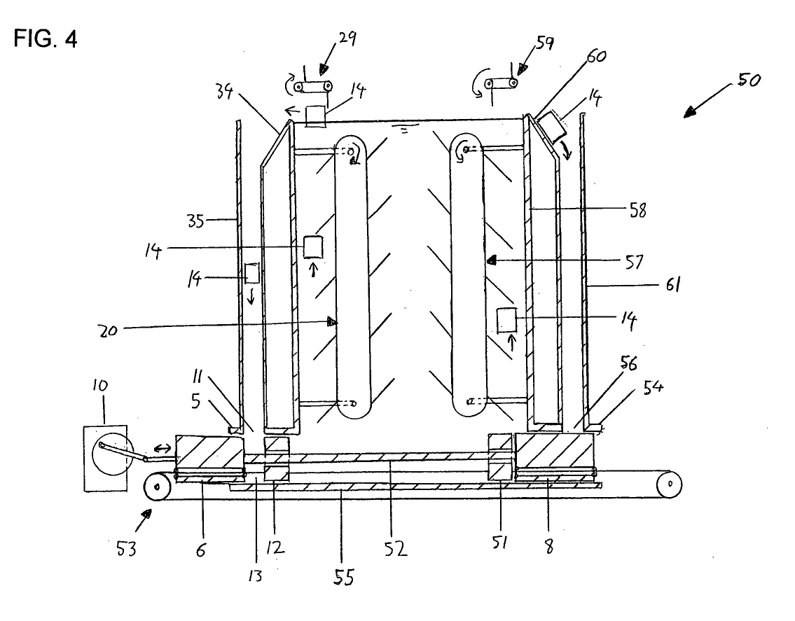

An energy transfer device 50 according to a second embodiment is illustrated in FIG. 4. The energy transfer device 50 is similar to the energy transfer device 1 of the first embodiment except that there are two seal pistons 12,51 movable along the piston connecting rod 52 by the seal piston drive means 53 and that the second end portion 54 of the cylinder 55 also has an opening 56 for receiving buoyant barrels 14. A second mill 57 is provided in the tank 58 to be driven by the barrels 14 entering the device 50 by the second opening 56 in the cylinder 55 and there is a second barrel removal means 59 and a second funnel 60 and chute 61 for returning the barrels 14 to the second opening 56.

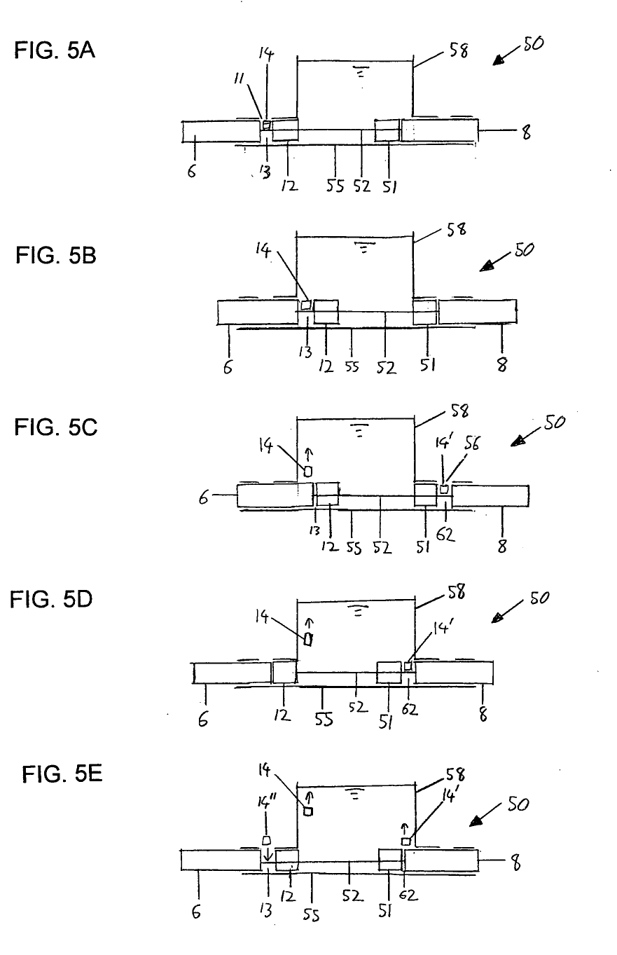

Referring to FIGS. 5A to 5E, the operation of the energy transfer device 50 will now be described. The mills 20,57, funnels 34,60, chutes 35,61, barrel removal means 29,59, reciprocating motor 10 and seal piston drive means 53 have been omitted for clarity.

A barrel 14 is dropped through the first cylinder opening 11 into a first pocket 13 formed between the first piston 6 and the first seal piston 12. The second seal piston 51 engages the second piston 8 (FIG. 5A).

The first and second pistons 6,8 are pushed along the cylinder 55 by the reciprocating motor 10 (see FIG. 4) and when the first pocket 13 is aligned with the tank 58 the barrel 14 is released (FIG. 5B) and its buoyancy causes it to rise.

As the first and second pistons 6,8 reach the maximum extent of their stroke the first piston 6 engages the first seal piston 12 causing the first pocket 13 to close up and the second piston 8 disengages from the second seal piston 51 causing a second pocket 62 to open up between them. A buoyant barrel 14′ is dropped through the second cylinder opening 56 into the second pocket 62 (FIG. 5C).

The first piston 6 with the engaged first seal piston 12 and the second piston 8 are pulled back along the cylinder 55 and when the second pocket 62 is aligned with the tank 58 the barrel 14′ is released (FIG. 5D).

As the first and second pistons 6,8 reach the end of their stroke the first piston 6 disengages from the first seal piston 12 causing the first pocket 13 to open up and the second piston 8 re-engages the second seal piston 51 causing the second pocket 62 to close up. Another barrel 14″ is received in the first pocket 13 (FIG. 5E) and the cycle is repeated.

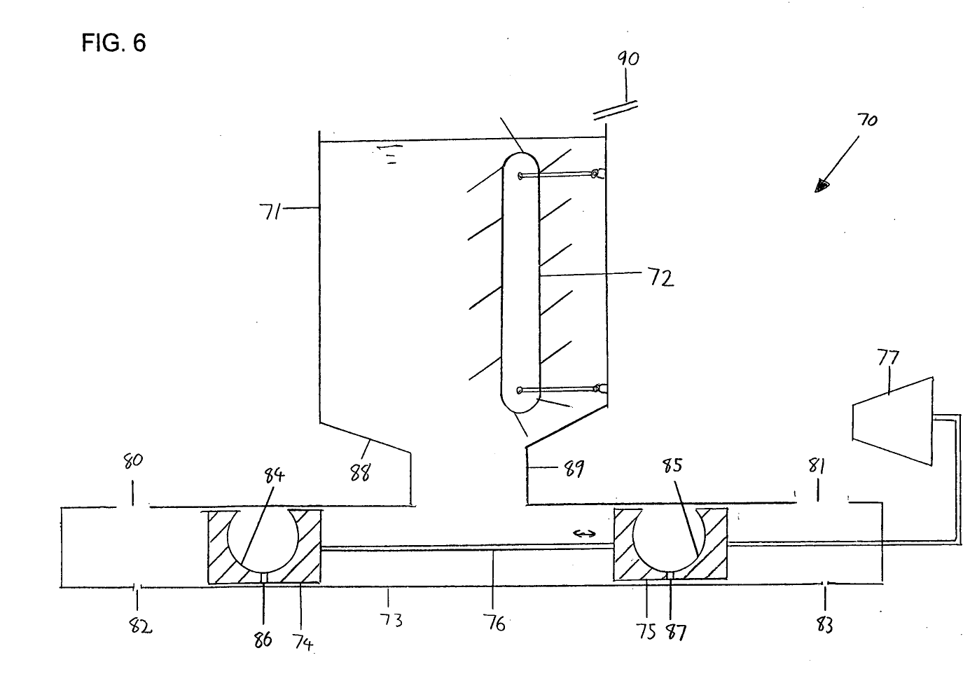

An energy transfer device 70 according to a third embodiment is illustrated in FIG. 6. Like the energy transfer device 1 of the first embodiment, the energy transfer device 70 has a tank 71 containing a mill 72, a cylinder 73, first and second pistons 74,75 connected to each other by a fixed connecting rod 76 and a reciprocating motor 77. The pistons 74,75 fit sufficiently tightly within the cylinder 73 so that a water seal is formed between the outer circumferential surface of the pistons 74,75 and the inner circumferential surface of the cylinder 73. Barrel removal means and funnels and chutes for returning barrels to the cylinder have not been shown and the device 70 does not have a seal piston.

The cylinder 73 is long enough to contain a full stroke of the pistons 74,75 and the top of the first and second portions 78,79 of the cylinder 73 each has an opening 80,81 for receiving a barrel. Aligned with each opening 80,81 is a drain hole 82,83 in the bottom of the cylinder 73. Each piston 74,75 has a rounded pocket 84,85 to receive a barrel via one of the openings 80,81 in the cylinder 73 and a drain 86,87 from the pocket 84,85 to the bottom of the piston 74,75.

The tank 71 has a funnel-shaped bottom 88 and the neck 89 of the funnel-shaped bottom 88 connects the tank 71 to the cylinder 73 beneath. A water supply 90 is provided to add water to the tank 71 when necessary.

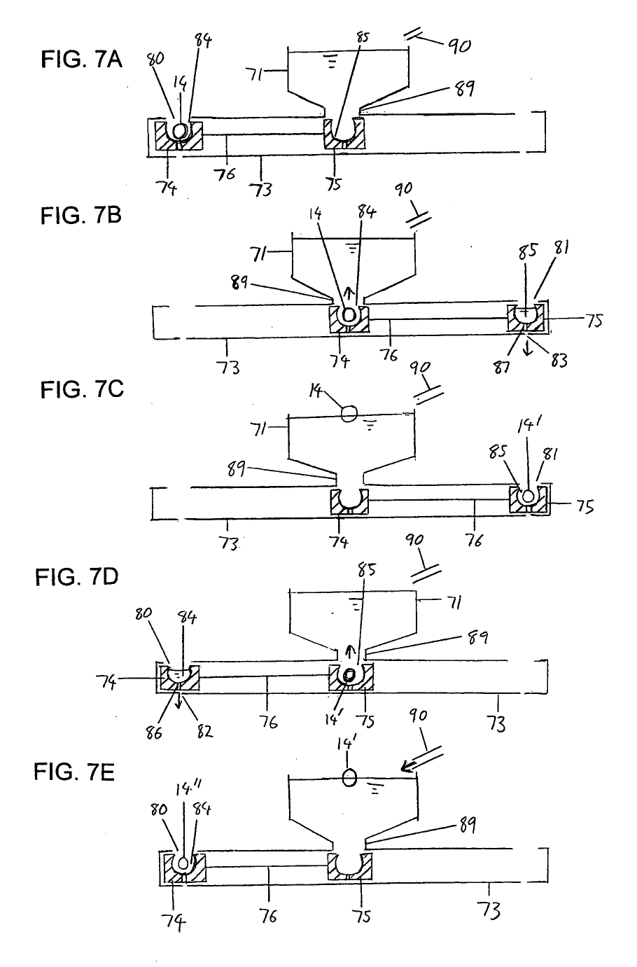

Referring to FIGS. 7A to 7E, the operation of the energy transfer device 70 will now be described. The mill 72 and reciprocating motor 77 have been omitted for clarity.

The tank 71 is filled with water and the force of the water acting on each piston 74,75 is effectively of equal value and act in opposite directions so that they effectively cancel each other out. This enables the pistons 74,75 to be moved with relatively little resistance. The pocket 85 in the second piston 75 is aligned with the neck 89 of the tank 71 and is filled with water from the tank 71. A buoyant barrel 14 is dropped through the first cylinder opening 80 into the pocket 84 in the first piston 74 (FIG. 7A).

The first and second pistons 74,75 are pulled along the cylinder 73 by the reciprocating motor 77 (see FIG. 6) and when the first piston pocket 84 is aligned with the neck 89 of the tank 71 the barrel 14 is released and its buoyancy causes it to rise. When the first piston pocket 84 is aligned with the neck 89 of the tank 71, the second piston pocket 85 is aligned with the second opening 81 and the second piston drain 87 is aligned with the second drain hole 83 so that water in the second piston pocket 85 is drained via the second piston drain 87 and the second drain hole 83 (FIG. 7B).

A buoyant barrel 14′ is then dropped through the second cylinder opening 81 into the second piston pocket 85 (FIG. 7C).

The first and second pistons 74,75 are pushed back along the cylinder 73 and when the pistons 74,75 have completed the stroke the second piston pocket 85 is aligned with the neck 89 of the tank 71 the barrel 14′ is released and water from the tank 71 fills the second piston pocket 85. The first piston pocket 84 is aligned with the first cylinder opening 80 and the first piston drain 86 is aligned with the first drain hole 82 so that water in the first piston pocket 84 is drained via the first piston drain 86 and the first drain hole 82 (FIG. 7D).

Another barrel 14″ is received in the first piston pocket 84 and the cycle is repeated (FIG. 7E).

During a cycle water enters the first and second piston pockets 84,85 and is subsequently drained from the pockets 84,85 causing water to be lost from the tank 71. The water supply 90 is used replace this lost water.

Whilst particular embodiments have been described, it will be understood that various modifications may be made without departing from the scope of the invention. For example, any suitable means may be used to transfer a barrel floating at the top of the tank to the cylinder. Any suitable means may be used to harness the movement of a barrel rising up to the surface in order to provide a driving force.

The seal piston or pistons may be driven by any suitable means along the connecting rod.

The cylinder which holds the pistons is not limited to having a circular cross-section. The cylinder forms cylinder means. The cylinder means may comprise, for example, two separate cylinders extending from opposite sides of the tank.

For the second embodiment, the first and second seal pistons may be replaced by a single seal piston reciprocable to open one pocket formed with either the first or second piston and at the same time close the other pocket formed with the second or first piston.

What is claimed is:

1. An energy transfer device comprising:
cylinder means connectable to a reservoir containing fluid;
first and second pistons connected to each other by connection means so as to be movable with a constant inter-piston distance, the pistons being mounted in the cylinder means; and
a pocket associated with one of the first and second pistons, wherein the first and second pistons in a first position enable the pocket to receive a buoyant object, and the first and second pistons in a second position enable the pocket to release the buoyant object into the reservoir so that movement of the buoyant object rising to the surface of fluid contained in the reservoir provides a driving force.

2. The device as claimed in claim 1, including a seal piston movable relative to the connection means between the first and second pistons, and the pocket is formed between one of the first and second pistons and the seal piston.

3. The device as claimed in claim 1, including driven means which is driven by the driving force provided by the rising buoyant object.

4. The device as claimed in claim 1, including means for returning a said buoyant object floating at the surface of the reservoir to the pocket when said first and second pistons are in the first position.

5. The device as claimed in claim 1, wherein at least one of said first and second pistons contains a said pocket.

6. The device as claimed in claim 1, wherein a pocket is associated with each of the first and second pistons.

7. The device as claimed in claim 6, including first and second seal pistons movable relative to the connection means between the first and second pistons, and a first said pocket is formed between the first piston and first seal piston and a second said pocket is formed between the second pistons and the second seal piston.

8. The device as claimed in claim 1, including first drive means for reciprocating the first and second pistons between the first and second positions.

9. The device as claimed in claim 2, including second drive means for closing up and opening up the pocket formed between one of the first and second pistons and the seal piston.

10. The device as claimed in claim 1, including said reservoir.

11. A method of transferring energy comprising the steps of:
providing a reservoir containing fluid, cylinder means connected to the reservoir, first and second pistons connected to each other by connection means so as to be movable with a constant inter-piston distance, the first and second pistons being mounted in the cylinder means, and a pocket associated with one of the first and second pistons;
positioning the first and second pistons in a first position;
receiving a buoyant object in the pocket; and
moving the pistons to a second position so as to release the buoyant object into the reservoir, the movement of the buoyant object rising to the surface of the fluid contained in the reservoir providing a driving force.

12. The method as claimed in claim 11, including returning the first and second pistons to the first position.

13. The method as claimed in claim 12, including returning a said buoyant object floating at the surface of the reservoir to the pocket when the first and second pistons are in the first position.

14. The method as claimed in claim 12, including receiving one of said buoyant object and another buoyant object in the pocket.

15. The method as claimed in claim 11, including providing a seal piston movable relative to the connection means between the first and second pistons, and forming said pocket between one of the first and second pistons and the seal piston.

16. The method as claimed in claim 15, including closing up the pocket formed between one of the first and second pistons and the seal piston after a said buoyant object contained in the pocket has been released.

17. The method as claimed in claim 16, including the step of returning the pistons to the first position, and one of the steps of (i) opening up the pocket again when the first and second pistons have returned to the first position, and (ii) opening up the pocket again by the time the first and second pistons return to the first position.

18. The method as claimed in claim 15, including providing first and second seal pistons movable relative to the connection means between the first and second pistons.

19. The method as claimed in claim 18, including forming a first said pocket between the first piston and the first seal piston, and receiving said buoyant object in the first pocket.

20. The method as claimed in claim 19, including closing said first pocket after said buoyant object contained in the first pocket has been released.

21. The method as claimed in claim 18, including forming a second pocket between the second piston and the second seal, piston, and receiving a second buoyant object in the second pocket.

22. The method as claimed in claim 21, including releasing said second buoyant object into the reservoir, and closing said second pocket.

23. The method as claimed in claim 20, including the step of returning the first and second pistons to the first position, and one of the steps of (i) opening up the first pocket again when the first and second pistons have returned to the first position, and (ii) opening up the first pocket again by the time the first and second pistons return to the first position.

24. A method of transferring energy comprising the steps of:
providing a reservoir containing fluid, cylinder means connected to the reservoir, first and second pistons connected to each other by a connection means so as to be movable with a constant inter-piston distance, the pistons being mounted in the cylinder means, and first and second seal pistons movable relative to the connection means;
positioning the first and second pistons in a first position and forming a first pocket between the first piston and the first seal piston;
receiving a first buoyant object in the first pocket;
moving the first and second pistons to a second position so as to release the first buoyant object into the reservoir, the movement of the first buoyant object rising to the surface of the fluid contained in the reservoir providing a driving force;
closing up the first pocket and forming a second pocket between the second piston and the second seal piston;
receiving a second buoyant object in the second pocket;
moving the first and second pistons so as to release the second buoyant object into the reservoir, the movement of the second buoyant object rising to the surface of the fluid contained in the reservoir providing a driving force;
returning the first and second pistons to the first position; and
one of the steps of (i) closing up the second pocket and opening up the first pocket again when the first and second pistons have returned to the first position, and (ii) closing up the second pocket and opening up the first pocket again by the time the first and second pistons return to the first position.
